(19) United States
(12) Patent Application Publication
(10) Pub. No.: US 2002/0120728 A1
(43) Pub. Date: Aug. 29, 2002

(54) Method and apparatus for network-enablement of devices using device intelligence and network architecture

(76) Inventors: Jason Braatz, Boston, MA (US); Michael Hendricks, Quincy, MA (US); Eman Safadi, Wellesley, MA (US)

Correspondence Address: Randy J. Pritzker, Wolf, Greenfield & Sacks, P.C., 600 Atlantic Avenue, Boston, MA, 02210, US

(21) Appl. No.: 09/747,749

(22) Filed: Dec. 22, 2000

(51) Int. Cl. G06F 15/173

(52) U.S. Cl. 709/223

(57) ABSTRACT

A network and system of electrical devices comprising a device-independent controller, a device-dependent controller, a console through which a user interfaces with the system, and a communication protocol for network-enabling the devices, and a method for such network-enablement are described. The integration of information content from a network, such as the Internet, with the network-enabling hardware and software of the present invention provides a flexible inexpensive way to enhance the overall utility and range of capabilities of a system of networked devices in a device-independent network application.

### FIELD OF THE INVENTION

This invention relates generally to the fields of device networking, management, and control. Specifically, this invention relates to the application of the above-mentioned fields in the context of electrical and electronic devices which can be network-enabled by communication over a network.

### BACKGROUND Of THE INVENTION

With the increase in the number and sophistication of household, office, commercial, computing, and military electrical and electronic machinery, appliances, sensors, and actuators, referred to herein as “devices,” the complexity of managing a collection of such devices increases. The difficulty of managing such a collection of devices is increased by the fact that the devices can be local or distributed, contain varying amounts of built-in processing power, and do not all adhere to the same standards of compatibility. Some means for controlling one or more devices remotely or over a network have been proposed for some time, and some basic implementations exist. Various approaches to device automation and remote control have been proposed and described in the following patents and publications, which are hereby incorporated by reference.

To Lea, et al., U.S. Pat. Nos. 6,032,202, 6,085,236, and 6,052,750, pertaining to networked audio-visual consumer electronic devices which are interoperable according to a predefined set of commands. The devices operate generally on a peer-to-peer network, with the commands and the user interface information all being exchanged at the time the devices are used. Any one device on the network is able to control any other device's operation in a symmetric fashion.

In U.S. Pat. No. 5,822,216, Satchell, et al., disclose a vending machine capable of transmitting to a central computer information regarding the purchase of an item from the machine using a modem connection over the internet.

An application which typifies the traditional approach to electrical device control over a network is given in U.S. Pat. No. 5,905,442, to Mosebrook, et al., wherein a device is used to control another using a simple communication protocol over a local network.

Nelson gives an application of device control in U.S. Pat. No. 5,710,605, in which a user is provided with television (TV) program guide listings obtained over the Internet, for example, to allow the user to selectively view TV programs by indicating those programs the user prefers using a remote control device coupled to the Internet.

The concept of using online TV guide listings also appears in Roop, et al., U.S. Pat. No. 5,790,198, where a system is provided for consolidating and presenting multiple sources of information to a user of a World-Wide Web (“Web”) TV appliance.

Communication protocols used for controlling smart appliances and Web TV devices are given, for example, by Minami, et al., in WO 98/19412, and Gaughan et al., in U.S. Pat. Nos. 5,844,552 and 6,073,171.

Finally, U.S. Pat. No. 5,973,696, to Agranat et al., discloses an embedded compiler for generating user interfaces for use over a network of devices.

To date, however, traditional concepts for device control have been geared towards convenience, but have generally lacked sophistication beyond basic ON/OFF functionality and alarm reporting. The applications available at present typically require direct user supervision and intervention, and are essentially limited to proxy, or remote control status.

In addition to functional limitations, many proposed device networking, communication, and control systems are prohibitively expensive. Some systems require coupling complex electronics requiring significant processing and data storage capabilities into every device on the network. Other systems require users to place full-scale servers in a home network to control the home devices on the network. Almost all existing systems are too expensive for widespread adoption by most consumers, require excessive space, energy, and upkeep, and are too complicated to integrate into the manufacture of many devices and appliances. This is especially true for smaller or cheaper devices whose cost will increase by a proportionally greater fraction when the networking hardware and/or software are included.

To make better use of the feature-rich devices and information content available today, and to allow a more integrated solution to management of a number of devices, as well as the ability to monitor and communicate with the devices at a reasonable cost, a need exists for a more sophisticated approach to device control, particularly using modem networking capabilities.

### SUMMARY OF THE INVENTION

The present invention addresses the needs discussed above, which in some embodiments provides a low cost, flexible system of hardware and software capable of providing control, monitoring, security, and convenience of operation of one or more interconnected electrical and electronic devices. By using new or existing hardware networking resources, as well as software and data content, devices can be integrated into an intelligent, content-rich environment. The devices are thus said to be “network-enabled”.

Accordingly, in one embodiment of the present invention, a system is presented, comprising a device-independent access controller (DIAC), having a DIAC network address, adapted for coupling to a network; a device-dependent access controller (DDAC), having a DDAC network address, adapted for coupling to the network, and adapted for coupling to a device, said device having a corresponding device functionality set; wherein the DIAC and the DDAC can communicate over the network using a communication protocol; and wherein the communication protocol supports a set of device-dependent commands, carried onboard the DDAC, said set of device-dependent commands allowing the DIAC access to the device functionality set.

In some embodiments, the system further comprises a user, wherein the user can be any of a human, a computer, and a device comprising at least a data processor.

In another embodiment, the DIAC is adapted for coupling to an external network, such as the Internet.

The DIAC may also be adapted for coupling to a second device, which can be adapted for hosting a user interface software client and/or has a second device functionality set. The user interface may come in many forms, and in some applications allows the user to access the device functionality set of at least one device coupled to the network. In some embodiments, the user interface is a graphical user interface, and can be prepared using any of the numerous currently-existing or to come standards and programming paradigms.

Access to a device's functionality set is accomplished in some embodiments using an intermediary device access controller coupled to the device via the network.

According to yet another embodiment, the DIAC and the DDAC are coupled to the same device and may be collocated thereon.

The system described by the current invention may also comprise a console adapted for coupling to the network in some embodiments. Such a console may a computer running an application program, a computer running a World Wide Web browser, a Wireless Access Protocol (WAP) appliance, a telephone, a personal digital assistant (PDA), or a custom console for accessing the network.

The DIAC and DDAC may communicate in some embodiments using a medium such as the Internet, an Ethernet connection, a wireless radio frequency (RF) channel, a telephone line, a fiberoptic data line, a cable television line, a modem connection, a wireless pager/packet network, a Bluetooth network, a Local Area Network (LAN), or a Wide Area Network (WAN).

For some applications, the device functionality includes data acquisition, which could be carried out by the first device, and may include information data such as device position. This data may be stored onboard the DDAC, stored onboard the device, or delivered to another device coupled to the network.

Some embodiments comprise a plurality of DDACs, each DDAC having a corresponding DDAC network address and being coupled to the network. The DDAC network address for a device can in some embodiments be assigned by the DIAC, which may also in some other embodiments act as a master controller for one or more DDACs.

It is within the scope of the present invention according to some embodiments for the device to be a component within a multi-component device, such as one of an ensemble of home appliances coupled to the network.

Another embodiment of the present invention provides a system comprising a DIAC having a DIAC network address, adapted for coupling to a network; a DDAC, having a DDAC network address, adapted for coupling to the network, and adapted for coupling to a device, said device having a corresponding device functionality set; wherein the DIAC and the DDAC can communicate over the network using a communication protocol; and wherein the communication protocol supports a set of device-dependent commands, obtained from information content found on an external network, said set of device-dependent commands allowing the DIAC access to the device functionality set.

Some embodiments provide a device-independent access controller (DIAC) adapted for coupling to a network operatively capable of using a communication protocol for communicating with a device-dependent access controller (DDAC) coupled to the network, wherein the DIAC uses a list of device-dependent operations, obtained from a source other than onboard said DIAC to exchange data with the DDAC.

The data exchange between the DIAC and the DDAC may occur in some embodiments only in one direction.

In other embodiments, the DIAC is implemented as custom hardware in the form of an application-specific integrated circuit (ASIC). The DIAC could also be implemented in other embodiments in hardware suitable for use in applications other than a DIAC, by execution of software commands on said hardware to achieve equivalent DIAC operations in the hardware. Additionally, the DIAC could be implemented in software, used in conjunction with an operating system and corresponding hardware.

Some embodiments of the present invention provide a device-dependent access controller (DDAC) adapted for coupling to a network, and adapted for coupling to a first device, said first device having a first device functionality set which is accessible to a second device coupled to the network, wherein the second device communicates with the DDAC using the network and using a communication protocol which includes a data representation corresponding to a first device functionality set, said data representation not being stored onboard the second device or onboard an embedded feature therein.

The DDAC may be alternately implemented as custom hardware in the form of an application-specific integrated circuit (ASIC) or in a circuit provided by the first device manufacturer at the time of production of the first device, or as a stand-alone circuit not embedded in the first device, having connections to the first device circuitry to allow it access to a first device functionality set.

Other embodiments of the invention teach a method for network-enabling devices comprising the acts of connecting at least one DIAC to at least one device containing a DDAC; operatively using a communication protocol for passing a DIAC signal from the DIAC to the DDAC; and returning a DDAC signal from the DDAC to the DIAC in response to the DIAC signal. Such methods may further comprise executing a function corresponding to a command signal sent by the DIAC. The methods may also involve returning a DDAC signal includes returning an acknowledgement signal, such as an ACK, or NAK signal.

The present invention provides in some embodiments a method for tracking a mobile asset comprising: obtaining position data for a position of the mobile asset using a network-enabled positioning device coupled to a first device controller; transmitting the position data over a wireless network using a first network-enabled communication device coupled to a second device controller; receiving the position data over the wireless network using a second network-enabled communication device coupled to a third device controller; and delivering the position data, once received by the second network-enabled communication device, to a data processing device coupled to a network.

In some embodiments, the method further comprises presenting the position data to a user in a graphical form. Such act of presenting the position data to a user in graphical form may include presenting position data samples represented graphically on a map of a geographic region, showing the position of the mobile asset at discrete sampling times.

The positioning device in some embodiments may be a GPS receiver, a LORAN receiver, radar, and a radio frequency beacon. The method may be used for tracking a mobile asset such as a motor vehicle, a marine vessel, a shipping container, an aircraft, and a human being.

According to some embodiments, the position data is a set of geographic coordinates including any of latitude, longitude, and altitude.

In some other embodiments, the method may further comprise recording the position data onto a networked storage device, where the act of recording the position data onto a networked storage device may include recording the position data onto any one of: a computer memory; a magnetic storage medium; an optical storage medium; and a printing apparatus, or the method may further comprise buffering at least one position data sample in a storage buffer collocated with the asset. Such storage buffer may be integrated into the mobile asset in some embodiments.

Other embodiments of the invention provide a system for tracking a mobile asset, comprising: a first device controller, coupled to a network-enabled positioning device, said network-enabled positioning device adapted for obtaining a position of the mobile asset; a second device controller, coupled to a first network-enabled communication device, said first network-enabled communication device adapted for transmitting position data over a wireless network; a third device controller, coupled to a second network-enabled communication device, said second network-enabled communication device adapted for receiving position data over the wireless network; and a data processing device, coupled to a network, adapted for processing the position data received by the second network-enabled communication device.

In some embodiments, the first network-enabled communication device is a paging device. In some embodiments the second network-enabled communication device is a paging device. Other embodiments provide a wireless network which is a two-way paging network.

The data processing device in some embodiments can be any of: a computer; a PDA; and a telephone.

In yet other embodiments, both the network-enabled positioning device and the first network-enabled communication device are collocated within an integrated wireless positioning apparatus.

The system may comprise a network comprising a plurality of first device controllers, coupled to a plurality of network-enabled positioning devices, said plurality of network-enabled positioning devices adapted for obtaining a plurality of positions corresponding to a plurality of mobile assets.

### BRIEF OF THE DRAWINGS

FIG. 1 shows a system-level view of a DINA embodiment.

FIG. 2 illustrates an example implementation of a console to be used in a DINA application.

FIG. 3 shows a component-level view of a DIAC embodiment.

FIG. 4 shows an embodiment of a DDAC at the component level.

FIG. 5 shows an example of the DIAC-DDAC communication scheme using OCIP.

FIG. 6 shows a typical OCIP header format.

FIG. 7 shows an embodiment of a telemetry application in a mobile tracking device using GPS and 2-way paging.

FIG. 8 shows a visual display provided by one embodiment of an asset tracking system with position and map information.

FIG. 9 shows an embodiment of visual tracking of a moving asset on a map graphic.

### DETAIL DESCRIPTION

A device is “network-enabled” according to the present invention by connecting it to an appropriate network through an access controller coupled to the device. A “conventional device” is one which is not network-enabled. A system of network-enabled devices comprises at least one device acting as a host or a master to a group of other devices on the network. The host device is coupled to a Device-Independent Access Controller (DIAC) which uses a communication protocol to exchange data and control commands and acknowledgements with the networked devices via their respective Device-Dependent Access Controllers (DDACs). The DIAC allows the host to function as a gateway to a collection of networked devices. The terms “device controller” and “access controller” are meant herein to include DIAC and/or DDAC controllers in general, where either one could be used.

The systems and methods described in the present invention are herein referred to as Device Intelligence and Network Architecture (DINA). The term reflecting the use of network architectures in a system which provides a measure of intelligence to the operation of the networked devices. The system is inherently agnostic to the type of network or devices coupled thereto. This allows flexibility to accommodate both old (legacy) devices outfitted for network enablement, as well as present and future devices so equipped.

According to the present invention, a device is associated with a set of functions that generally relate to the range of actions or features the device is capable of performing. This set of features and capabilities are generally referred to herein as the device's “functionality set”.

For example, a wireless telephone device may include, as elements of its functionality set, various call functions, display functions, ring functions, data storage functions, power management functions, etc.

In traditional devices, a user gains access to the functionality set of a device using the control features provided on a control pad for example. In a wireless telephone this might entail pressing the buttons on the device control pad section to access the phone's various features.

A network-enabled device can enhance the uses of the device by allowing access to the device's functionality set through access controllers adapted for such access. Various ways of implementing this access are described in more detail below.

Device intelligence may be achieved or enhanced by using data content available through the network to assist in decision-making or evaluation, control, communication, and customization of the device operation, its setup, and its relation to other devices coupled to the same network as the device or to other external networks, themselves coupled through some means to the device's network.

Network enablement makes a device more useful, more flexible, and adds value to the device. The set of functions of which a device is capable is usually accessed by manual operation of a set of controls on a control pad provided by the manufacturer. The device controls are almost always conventionally located on the device itself, such as the case with a typical washing machine, clothes dryer, telephone, radio, or microwave oven. Sometimes a remote control unit is provided for convenience, such as a TV/VCR remote control unit, or the heating/air conditioning controls attached to the walls of many homes. In these cases, the remote control unit is basically a spatially-displaced version of the controls on the device itself with some one-to-one correspondence of a set of physical controls (e.g., buttons) for another set of physical controls.

Conventional devices are usually operated independently of one another by an operator, who controls the devices manually, whether locally or remotely as discussed above. By contrast, network-enabled devices, as provided for in the present invention, are capable of being operated manually or automatically, locally or remotely, independently or in concert with the operation of other devices on the network. While device control is an important feature of the DINA teachings, it is but one feature, integrated into a broader capability scheme offered by the abilities of a network-enabled system. A network-enabled device may further use software and/or data content available through the network to increase its utility.

The network may be in one of many forms, e.g., the Internet, World Wide Web, wireless RF, cellular network, paging network, Bluetooth network, etc. Many advantages may be provided once the devices are network-enabled. These include simple remote control of the built-in features of the devices, as well as more sophisticated functionality, which can be achieved using a cooperating, communicative plurality of devices on a network. For example, devices with common functionality (e.g., entertainment system components, telemetry system devices, climate-control system devices) can be made to operate in a more efficient and cooperative manner, sharing information and resources regarding their individual and collective operation.

A user may interface with the DIAC using a console (180) in some embodiments. The console (180) may take one or more forms as called for by the specific application at hand. For example, a user can access the functionality set of a device by way of a software agent adapted for interfacing the device to a DIAC via the network. The software agent may be implemented using a server, micro-server, browser, or one of any application protocols and markup languages now available or becoming available in the future.

While examples of devices and applications using the present invention are provided throughout this document, these examples are for illustrative and enablement purposes only, and should not be considered a complete set of possible embodiments and applications. Full use of existing and new technologies is proposed herein for the purposes of the invention. It should be evident that the examples given herein are but a glimpse of the vast range of possible uses for such a technology. Almost any electrical or electromechanical device of arbitrary architecture and complexity can be network-enabled using the DINA teachings described herein.

For example, an air conditioning unit which normally requires direct intervention by the user, or relies on simple timer and thermostat functions to operate, can be made to operate more effectively when it is network-enabled. The unit may obtain useful data over the network such as weather forecasts, fuel prices, or the work schedule or vacation calendar of the occupants of a building to improve the comfort or economy of operation of the networked climate control equipment in the building.

Another example of added utility, which becomes available upon network-enabling a set of devices may involve home entertainment devices. The teachings of the present invention may be used to embed device access controllers into a home's stereo system, television, VCR, telephone, etc.

Once a group of devices are network-enabled, a user can easily and securely access the functionality of the devices independently or as a group. For example, while the user is away on travel, he or she may send a programming command to the TV/VCR equipment to record a favorite broadcast the user enjoys watching when at home. Since the devices are coupled to a network, they can now search the Internet for example, to obtain the channel and time for the show requested by the user and record it at that time.

Alternately, the user may request that a device notify him or her via an electronic or a telephone message informing him or her of the occurrence of such favorite programs (e.g., related to volcanoes), possibly asking the user whether he/she wishes to record the program, save it in a database, forward it to a friend, etc. Recorded content may be more easily accessed using a server message block (SMB) service, allowing a user to view the networked devices and files stored within them as mounted drives. This will simplify the task of uploading, downloading, streaming, deleting, organizing, sharing, and viewing this content.

Time-shifted programming and video on demand can be easily accomplished if a storage device is connected to the network. For example, a digital storage disk drive can receive streamed content from the television receiver device, and archive the content for viewing at the convenience of the user. Other video content can be accessed via the network from other sources or archives or service providers as desired. In fact, given the necessary bandwidth, a user can enjoy programs he/she normally views at home (such as the local news) while away on travel in another country by using a computer on a network capable of playing back the streamed or archived content. Such playback may occur at a later time for convenience, or if a time difference due to geographic separation so warrants.

Another field which can benefit from the use of network-enabled devices is that of telemetry. Telemetry is loosely defined as the science and technology of automatic measurement and transmission of data by wire, radio, or other means from remote sources. A related area, sometimes known as reverse telemetry, or the use of network connectivity to empower a user or a commercial environment with relevant data for more intelligent decision making. These fields will be collectively and individually referred to herein as “telemetry.”

A brief exemplary list of applications made available using such technology are tracking of mobile assets for use in courier and trucking fleets; identification and tracking of drivers on the roads and their observance of traffic regulations, including for determination of fault in accidents or for issuance of traffic violation citations; real-time tracking of valuables or stolen property such as vehicles, computers, etc.; real estate and sales route and trip tracking; emergency vehicle dispatch and guidance; personnel safety and management; route management; and location-based advertising, including time-based examples.

Examples of the use of network-enabled devices in telemetry applications might include the tracking of mobile assets or vehicles, whereby a networked communication device, such as a two-way pager, may be carried on a vehicle, a package, a shipping container, or even personnel for purposes of collecting data regarding the asset's location or environment, or for providing the asset or its user with real time location-dependent information relating to the asset.

Data reflecting the real-time location of a fleet of taxicabs or delivery trucks can be provided to a central computer where an operator or a manager or a dispatcher can view the locations of the vehicles, or the data may be stored into a database for security or record keeping purposes, or for future processing to develop better business models. Asset data can also be provided to a machine or computer application for automated or decision-based action.

Some telemetry and reverse telemetry applications can benefit from combination with other technologies, such as positioning systems, for example global positioning satellite (GPS) systems or computer-assisted GPS systems. Other benefits can be obtained by combining DINA technology with communication systems, such as telephones, cellular systems, paging systems, etc., which if further coupled to positioning systems can provide data concerning the location of the devices and facilitate one-way or two-way transmission of any necessary information or content between various devices on the network and the network at large.

For instance, a real-estate agent might have a mobile telemetry device, having the functionality of a network-enabled communication device, such as a pager, and a GPS receiver for purposes of tracking and recording a vehicle's whereabouts. This data can be provided, possibly graphically superimposed onto a map, to a client who wishes to review a record of the streets traveled on a house-hunting trip. The position data may be transmitted by the communication device to a central computer over the communication (e.g., paging, cellular, satellite) channel or stored locally in memory or on an appropriate storage or printing apparatus. If the communication link between the device and the central computer is temporarily lost, but the GPS signal is available, the device may store or buffer the position data locally for uploading to the central unit at a subsequent communication when the connection to the central unit is restored.

These applications could save effort and improve efficiency in situations where a customer is billed for transportation by the distance traveled. For example, a taxi service, moving service, or delivery service could automate the calculation of the travel distance, or an employee requiring mileage reimbursements could enter a billing number upon embarking on each trip on business that would provide data for generation of a travel log or a billing entry.

Coupling the network-enabled devices to data such as maps available over a network, including an external network such as the Internet, would further improve the visual value of such position data as discussed above. Currently, several map providers offer Internet-based map services which can be adapted for use in the present telemetry applications.

Alternate embodiments will be apparent to those skilled in the art. For example, shipping or transportation or law-enforcement entities might use such vehicle-mounted network devices to track objects or vehicles or personnel either in real-time or by uploading and archiving the data on a centralized computer or storage system.

Similarly, other positioning systems such as LORAN, radar, radio signal beacon triangulation, etc. might be used instead of or in conjunction with the GPS positioning described above. The invention may be used in dedicated, proprietary devices, or may be added onto existing or legacy devices outfitted with network-enabling hardware and software at or after the point of manufacture. Devices may be retrofitted with access controllers at any point in the manufacture-sale-upgrade cycle.

Other uses of DINA technology using telemetry concepts might be the selective location-dependent transmission of road traffic information to a driver of a vehicle in transit from one location to another, advising the driver of upcoming weather, construction, accident, or congestion problems. The value of such an application is enhanced by the ability to access a real-time network to gather relevant data. For example, by tying into traffic signal databases, monitoring radio traffic reports, emergency channels, traffic cameras, etc. Currently, numerous services on the Internet offer live traffic reports which may be adapted for use in the present invention.

Some embodiments of the above concepts use Internet-based networks to send and receive data or integrate the data into spatial databases such as Oracle 81 Spatial® or SQLServer™ or use mapping information systems such as ESRI™, or MapInfo. When using paging networks, systems taught by the present invention may use the 2-way ReFlex25 or ReFlex50 standard, or other services such as those from Skytel or MCI Worldcom.

The utility of network-enabled tracking systems may be further extended by provision of a means for coupling the positioning device with one or more personal digital assistant (PDA) devices using the concept of network intelligence. An address book function in a networked PDA, whether handheld, vehicle-mounted, or a personal computer, may be used to pull up the street address of a contact person to whom a visit is to be made. This address is brought up on a map, and a best-route of travel, possibly accounting for contingencies to be described below, will be displayed on the map showing the current location and the destination. The best-route may be shown in addition to a real-time path of travel also laid out on the map.

Contingencies such as the need to fuel the vehicle at a station lying off the best-route may be taken into account, since such station locations and their hours of operation can be available over the network. Other situations, such as unusual traffic conditions, may also be used to determine the preferred best route. Furthermore, if some objects, packages, or passengers need to be picked up or dropped off on the way to the destination, a best-route using these criteria would be computed.

A person driving the group to work may enter or speak the names of the coworkers she is picking up into a computer calendar or PDA or specially-adapted cellular telephone. The addresses of the coworkers exist in the driver's contacts list or phonebook and are provided to a networked navigation device in her car. The navigation device or another computer then plans the route from the driver's home to her work, including picking up the coworkers on the way. The route may be pre-planned if such an event was entered into the driver's calendar utility on a networked device, alerting the driver to the expected time of travel. If morning traffic reports indicate especially congested conditions along the route, a network-enabled alarm clock device may advance the time of wake-up accordingly, as will other morningtime networked devices.

On the way home from work that evening, the driver's spouse may telephone or send an email message requesting her to pick up an item from the drycleaner's after dropping off her passengers. This request might prompt an automated recalculation of the homeward travel route, possibly after asking the driver whether she agrees to the request.

Another driver who uses his car for frequent business trips may benefit from having a network-enabled calendar and address book coupled to his car's navigation system. Here an alert notifying the driver on the road that it is time to go to a meeting at a client's address. This alert may be followed by a rendering of a map and best route on a graphic display or using text or voice commands coordinated with position data to direct the driver to the location of his appointment.

Archiving of travel data such as position as a function of time, travel time, delays not anticipated by road condition data providers, etc. might be used to help build an expert database for future trips made by the driver or other drivers. For example, a vehicle tracking system tracking more than one vehicle simultaneously might use data gathered from one vehicle that recently traveled a certain road to inform drivers on that road who follow what the expected travel time on that road will be based on data obtained from the leading vehicle. Trends thus collected can be used to anticipate conditions based on past performance in that location if a need to fill in missing traffic data exists. Another feature might fill in missing road travel information with performance of other correlated similar traffic locations elsewhere with similar conditions.

Placing a number of mobile telemetry devices in vehicles traveling the roadways, for example being attached to public transit, taxi, government, or volunteers' vehicles, will allow for tracking of the marked vehicles for the purpose of monitoring the flow and movement of vehicle traffic on the roadways and making announcements, issuing travel advisories, providing input to traffic routing and best-route calculation applications, and making travel time predictions as discussed above.

Time savings and reduced errors and incidents of fraud can be achieved using telemetry according to the present invention by network-enabling the odometers and/or fuel gauges of certain vehicles. For example, a rental car outfitted with DINA may automatically be made to report the odometer and/or fuel gauge reading to the networked check-out station for billing and fraud-prevention purposes. Fully-automated, self-service, vehicle check-in may be achieved in this way.

In some cases it is desirable to allow rapid law enforcement tracking of certain vehicles, such as armored cars, police cars, or perhaps the personal vehicles of persons on probation in the justice system. The utility of real-time tracking of these vehicles or their occupants can be a time-saving measure and can benefit public safety and order. For example, public or government vehicles that are checked out for official use can be monitored for their position or odometer readings.

Other public utility applications include the planning, modeling and updating of public roadways. Here the travel patterns of vehicles using the roadways can be used to determine when and where traffic congestion occurs in some area. The data can be used to plan future expansions or road additions. Ultimately, continuous collection of road and traffic data can lead to a data collection which is sufficiently dense and complete to make accurate predictions of expected travel times, based on the present date, time, and traffic history. This could be done using sophisticated computations analogous to those used to predict weather patterns.

Certain business advantages and methods for revenue generation become available when using the DINA system described herein. For example, service revenues that can be generated using such telemetry systems include:

Application Service Provisioning of mapping services for object and person tracking and for fleet or company management;

Provisioning of location-sensitive intelligent services that would be transmitted to the networked pagers;

Monthly subscription fees for online map-based tracking and telemetry;

Individual transaction fees to end-users or other service providers;

Licensing fee to other service providers;

Advertising fees to vendors and services that are utilizing the telemetry and network infrastructure to reach consumers;

Alarm services, including commercial, residential, military, and industrial.

Entities such as airports, shipping lane, harbour, warehouse managers, and shopping stores and malls can use data from network-enabled telemetry devices to optimize the construction or configuration and layout of their facilities. For example, an agency responsible for directing shipping traffic can optimize the travel lanes for marine vessels.

In another application, the operator of a shopping mall or retail store or grocery may install mobile telemetry units onto shopping carts, baskets, product scanners, or order-taking units in their facility to determine where shoppers go, how long they stay in each location, how long and when they shop, where the most congested isles are, possibly rearranging their merchandise or stores to best cater to customers known to take certain paths. Retailers currently use ad-hoc methods for arranging merchandise to best suit the needs of their customers and increase profits. The present invention enables better data collection to improve the accuracy and knowledge of customer shopping behavior and trends. This data can then be collated, sold, traded, or used in other research.

Targeted advertising material can also be placed along the best shopping paths depending on the type of shopper most likely to use that path, etc. The data collected may further be combined with actual sales data to obtain more useful conclusions about the shopping population. Live alerts may be provided to shoppers based on location, time, or previously-known shopping history data. For example, as a shopper passes by an item on sale or an item similar to one he or she has paused to inspect during a shopping trip an alert such as a visual indicator placed on the shopping cart or on the product shelf can illuminate, point, or otherwise bring the item to the shopper's attention.

If the shopper is in a grocery store and stops to buy a birthday cake, the indicator may alert the shopper when he or she passes by the greeting card isle. The shopper may additionally have data from a shopping list at home or on a PDA for example be used to help guide the shopper to the items needed or suggest commonly bought products that the shopper or others have bought when buying a corresponding product.

Another telemetry example is the time and location-dependent transmission of advertising content to travelers on the road, such as the location of nearby restaurants if the time of day is around a mealtime, or the location of nearby gas stations if the vehicle requires refueling.

Customer profiling methods, and methods for achieving and mining customer-related data can be enhanced using a DINA system by including hardware and/or software on a credit card, debit card, or store card. The present invention may be practiced using a minimalist DDAC footprint implemented within the card, operative with a DIAC coupled to the card reader, possibly at the point of sale.

A list of items needed to be picked up for home or work which are entered into a networked device can trigger an alert on a mobile (e.g., handheld) networked device or on a vehicle-mounted networked computer, provided a positioning means (e.g., GPS) is also coupled thereto. The alert could be an automatic message to pick up an item on a shopping list from a grocery if the mobile unit is in the vicinity of the grocery. Alternate examples of this kind abound. An alert may tell one to pick up flowers if the person carrying the networked mobile device is near a florist shop and his or her calendar has a special occasion (e.g., wedding anniversary) marked. A vehicle-mounted device could alert the driver to the presence of a nearby car dealership or service station if a service interval or maintenance flag is due.

The particular application will determine the method to be used to communicate the data over the network. Some considerations include speed, security, volume of data, quality of service (QoS), and compatibility issues. In some embodiments encoded and encrypted transmissions using 128 bit encryption will be required. In other embodiments, the data may be transmitted using World Wide Web-based Internet operation; non-Web Internet-based operation using File Transfer Protocol (FTP) or Telnet; Dial-up or DHCP/BOOTP configurations; wireless, cellular, paging network NMEA 2.0, Reflex 25, Reflex 50, Bluetooth, or the wireless communication transport protocol (WCTP) specifications. Multiple concurrent communications, possibly using more than one mode or more than one communication protocol can be employed. For example, both low-and high-bandwidth communication paths can be used for a transaction that might so warrant. Say a video streaming application that requires the streaming of a large quantity of video over a wideband network might be used in conjunction with DINA protocol signals that travel over a narrowband channel. The two types of communication could also be performed at different times if desired, such as in the case where a laptop user wishes to download or stream an archived TV broadcast but only has a cellular or a paging network available. The TV content in this case can follow later when an Internet connection is properly established. Multiple communication paths can be useful for reasons of redundancy (some data or commands simultaneously transmitted using two channels), security (e.g., partial data sent encrypted over a separate expensive communication path), or reliability (in case one communication mode is accidentally disconnected or becomes noisy).

Other applications in which network-enabled devices will play a useful role include monitoring and servicing of automatic bank teller machines (ATM), parking meters, vending machines, and toll booths. By connecting such devices to a network, it will become easy to monitor the operation of such devices, and the device can be made to automatically send a request-for-service appointment message to a central station, coordinated using a calendar, for example, or requesting refill of a particular product in a vending machine, or a tamper warning from a parking meter.

It should be clear that a great advantage of network-enabled devices is not merely the ability to remotely control them, but their ability to use data and content from other devices on the network and from other networks, such as the Internet or World Wide Web, and to coordinate the tasks being performed in an intelligent and efficient manner.

Further enhancement of the functionality of the devices can be obtained by leveraging the vast existing information base, which resides on local and remote systems connected to intranets and internets. For example, information content available on the Internet can be used in raw form or following some processing steps to give the devices real time intelligence features, or decision-making abilities that they would otherwise lack.

In some situations, for example in rural locations where conventional wireless telephony services may not be available, the communication between the network and the network-enabled devices may be carried out over existing paging networks. Such paging networks, which have experienced a recent decline due to the rising popularity of cellular telephone communications, have a wider area of coverage and provide an underutilized segment of the wireless bandwidth, which may be utilized for low bandwidth requirement applications such as telemetry, device monitoring, control and communication.

The ability of the network application hardware and software to communicate over arbitrary communication networks should be emphasized. This network-agnostic feature makes it easy to use a large variety of devices using a communication protocol. While each device may carry on board (or is coupled otherwise to) a device-dependent element to access the set of functions provided by that device, called the Device Dependent Access Controller (DDAC), the devices communicate together and are remotely accessed by the user or a host or master device containing (or are coupled otherwise to) a device-independent element, called the Device-Independent Access Controller (DIAC).

Almost any electrical device or electromechanical device can be enabled using the present invention. Therefore, it is beneficial to include a level of control which is device-independent to allow for interaction between devices from multiple vendors or of different types. This aspect and an exemplary implementation architecture will be described in detail below.

The systems and devices described herein may use a variety of proprietary or commercially-available (off the shelf) hardware and software components. Systems typically comprise a group of devices to be network-enabled, which utilize Device-Dependent Access Controllers (DDACs) and software for operating said DDACs; one or more Device-Independent Access Controllers (DIACs), and software for operating said DIACs. A DIAC is normally connected to a network, such as a Local Area Network (LAN), the Internet, etc., over which the devices can be monitored or controlled or programmed using some protocol such as TCP/IP. The DIAC and the DDAC can communicate over a communication channel such as the ones described previously. The communication between the controllers can use a protocol which depends on the application and the devices in use. Some preferred means of achieving the controller-to-device hardware coupling are:

1) Digital integration, wherein the DDAC communicates with the OEM processor, instructing the OEM processor to control the device, using the OEM processor's existing electronics.

2) Integrating DDAC (and/or DIAC) into the OEM processor hardware. This may be done by the addition of the controller circuitry to the processor at time of manufacture, or by using existing processor pathways for access controller logic. In this case, the OEM processor executes the controller microcode instructions, and the controller and OEM processor are collocated on a single unit.

3) Tapping into the existing device circuitry, using the existing circuit boards as connections between an added-on controller hardware and the device controls connections.

4) Interfacing the access control module to the OEM logic via an installed sub-assembly or “daughter board” that connects by hugging into a socket or through a ribbon connector with the OEM “motherboard”.

A user interface may be included in the application to enable more flexible or intuitive use of the devices, such as a Graphical User Interface (GUI), a Voice User Interface (VUI) or another representation to aid in menu navigation and operation or the devices. In one embodiment, a device having a conventional local operation interface on the device, such as a faceplate with control buttons, may be operated by a user using a computer screen, onto which the faceplate and controls were graphically reproduced by some means such as photography, in order to make the image presented to the user on the screen appear familiar. This technique may save the user the effort of learning a new interface if he or she was accustomed to using the device locally from the device's local faceplate controls. This technique also leverages the work of the device manufacturer who typically has developed an ideal user interface for operating the devices. Additionally, this method can provide the device manufacturer with added exposure of a product and its mark.

One preferred communication protocol for connecting the devices will be explained in detail below. In some embodiments, the communication between the DIAC and a DDAC is achieved using a proprietary protocol called Object Control Interface Protocol (OCIP), from Xypnos, Inc., which passes datasets between the DIAC and the DDAC containing information which may include device identification headers, error codes, acknowledgement codes, and various command and query messages. The OCIP can operate at several levels of complexity, called Modes or Forms, depending on the complexity of the devices. A discussion of the OCIP and a specification for the preferred embodiment thereof are given in Appendix A.

The overall DINA system may be provided in more than one implementation, such as custom-manufactured by Xypnos, Inc. or another party, or integrated by the Original Equipment Manufacturer (OEM) at the time of manufacture of the network-enabled device, or as a cost-added option to be subsequently installed at the factory or point of sale for example.

### DESCRIPTION OF THE PREFERRED EMBODIMENTS

The present invention may be better understood with the aid of this detailed description in conjunction with the accompanying drawings, which carry tag numbers corresponding to those used in the description.

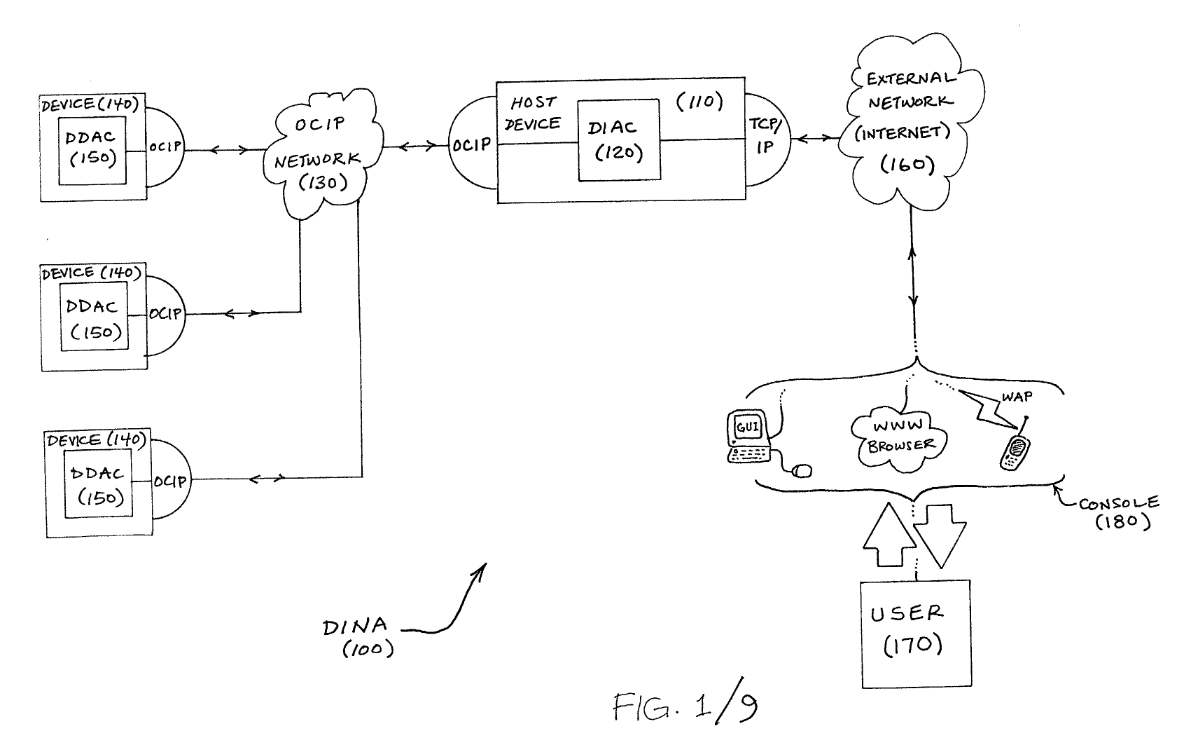

FIG. 1 shows a system level example of a DINA embodiment (100). This system comprises one host device (110) containing a DIAC (120). The DIAC (120) is coupled through an OCIP network (130) to one or more devices (140) each of which contains a DDAC (150) module. The devices (140) and the DDAC modules (150) contained within, may be directly coupled to the OCIP network (130), or they may be connected through OCIP compatible connections to other DDAC or DIAC components.

The OCIP network (130) can be any specialized or generic network capable of carrying OCIP commands and information between DDAC and DIAC components. For example, the OCIP network (130) may be a local area network LAN (LAN), radio frequency wireless communication network, or the Internet.

The DIAC (120) is also coupled through a wide area network such as the Internet (160) to a console (180). The console (180) can have many forms including a personal computer using a graphical user interface, a worldwide WEB browser, a wireless access protocol (WAP) telephone, etc. A user (170) can access and control and monitor the devices (110) and (140) through one or more user interfaces provided by the console (180).

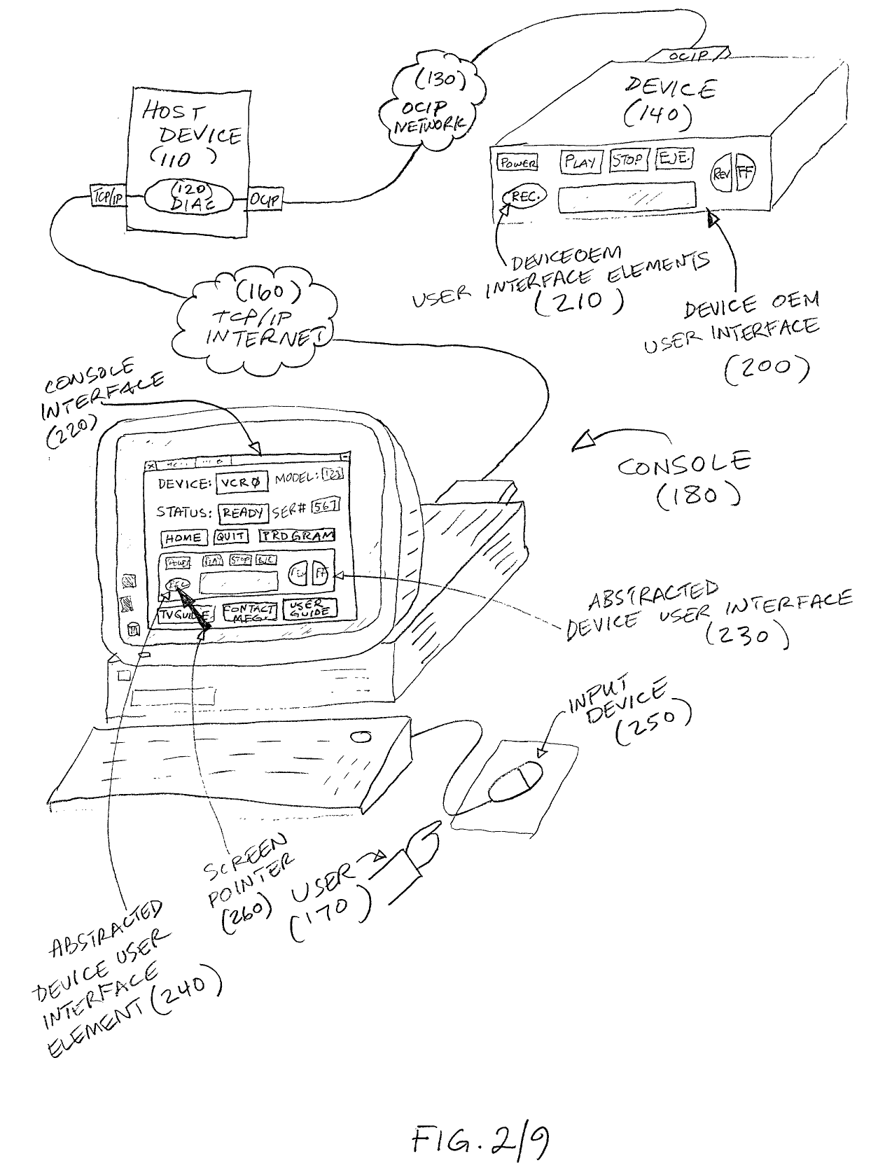

One example of an implementation of a console and its use is shown in FIG. 2. The figure shows a device (140) having a device original equipment manufacturer (OEM) user interface (200) and at least one device OEM user interface element (210). A DDAC (150) within the device (140) is coupled through an OCIP network (130) to a host device (110) containing a DIAC (120). The DIAC (120) is coupled through the Internet (160) to a personal computer having a graphical user interface console (180). The console (180) has a console interface (220) on which an abstracted device user interface (230) including at least one abstracted device user interface element (240) are depicted.

A user (170) can interact with the console interface (220) using some input device (250), such as a computer keyboard or a computer mouse. The input device has a corresponding screen pointer (260), for example, which can then be used to actuate the functional elements of the device (140) via the elements (240) of the abstracted device user interface (230).

One advantage of the above-described method of interaction between the user (170) and the device (140) is that the graphical representation given by the abstracted device user interface (230) can be made to closely resemble or identically reproduce an image of the device OEM user interface (200). This way a user (170) familiar with the device OEM user interface (200) will immediately recognize the visual abstracted device user interface (230), and will not require further learning in its use. Additionally, the OEM may benefit from increased product visibility and mark recognition.

Other possible advantages to using such a user interface console paradigm include seamless integration of information content available over the Internet, such as television listings, and online user guides.

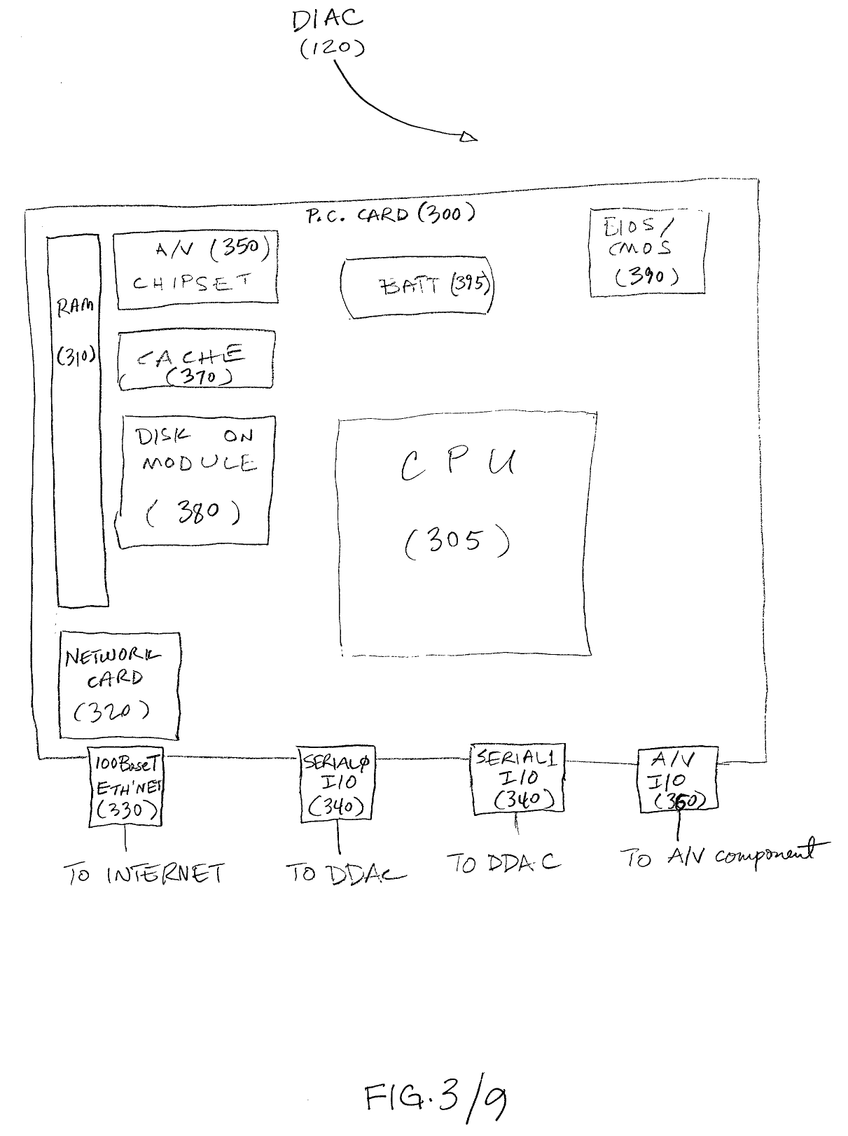

FIG. 3 shows a component view of a DIAC (120) embodied on a printed circuit card (300). The printed circuit card (300) has attached several other components, such as a central processing unit (CPU 305), random access memory (RAM 310), a network card (320), a means of coupling the DIAC (120) to the Internet, e.g., a 100BaseT Ethernet connection (330), one or more serial input/output (I/O 340) connectors, and other I/O connectors as required, such as an audio visual input/output connection (360).

Other circuits to support the DIAC's (120) functionality are also included on the embodiment given in FIG. 3, for example, an audio visual device chip set (350), primary and/or secondary memory cache (370), a disc on module (380), a BIOS/CMOS (390), and a battery (395).

Of course, the DIAC (120) may contain many more or fewer components than those described above for illustration purposes.

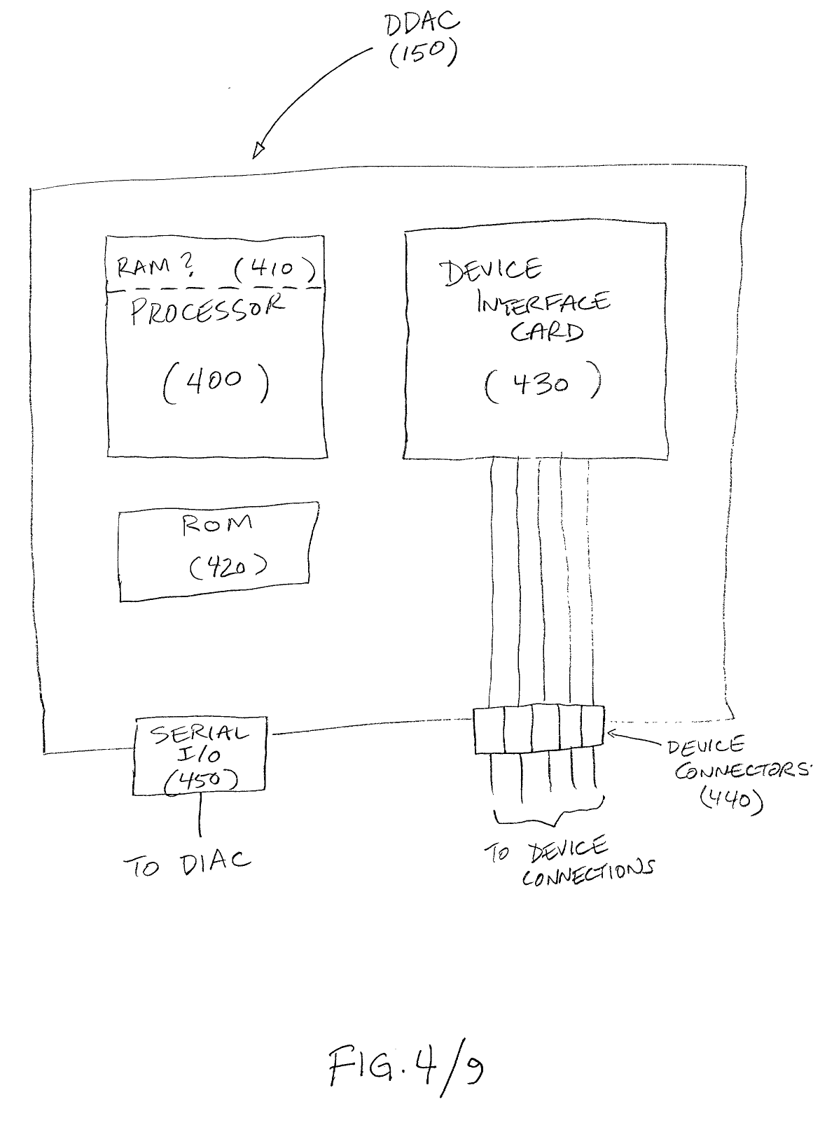

FIG. 4 shows a component level view of a DDAC embodiment. Due to the wide variety in the devices (140) and their functionality, the DDAC (150) may take on many forms. In some embodiments, but not all, the DDAC (150) may comprise a processor (400), possibly including some memory (410), a read only memory (ROM 420), capable of storing the identity and basic functionality provided by the DDAC (150), a serial I/O (450) connection, and one or more device interface cards (430). The device interface card (430) is used for coupling the DDAC to the device (140) through device connectors (440).

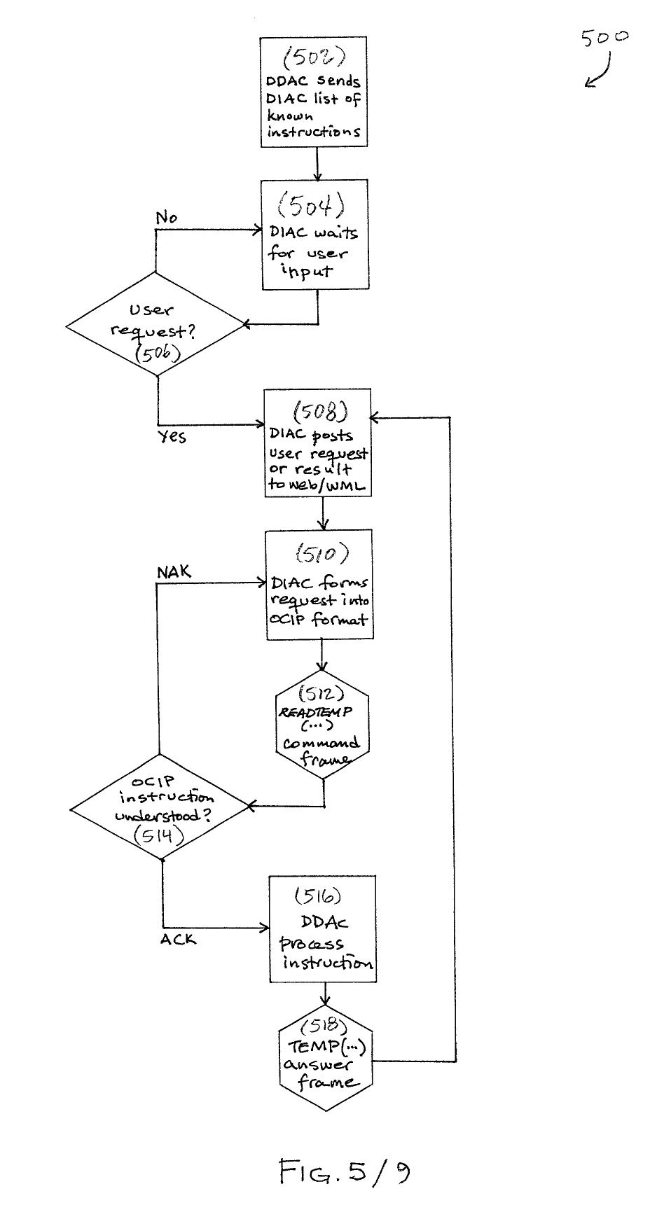

FIG. 5 shows one embodiment of a communication sequence delivering a user request to a device and returning the result to the user via the console. The communication sequence (500) is an exemplary illustration comprising the following acts. In act (502), the DDAC sends the DIAC a list of known instructions. The DIAC waits for a user input in act (504). A user request act (506) will cause the DIAC to post the user request using the console device in act (508). Otherwise, the DIAC continues to wait for a user input, in act (504). The DIAC next forms the user's request into an appropriate OCIP format, in act (510).

In this example, the user's request was for a temperature reading device to deliver a temperature. The request is delivered in an OCIP command frame format, for example, READTEMP ( . . . ), in act (512). If the OCIP instruction was understood by the DDAC, in act (514), an acknowledge (ACK) signal is sent back to the DIAC, and the DDAC processes the instruction in act (516). If the OCIP instruction was not understood, then a not acknowledge (NAK) signal is returned to the DIAC, and the DIAC attempts to form the request into an OCIP format in act (510).

Once the DDAC receives the temperature measurement answer from the device, the TEMP ( . . . ) answer frame is formulated in act (518), and returned to the DIAC for posting the results to the console, in act (508).

A user request act (506) will cause the DIAC to post the user request using the console device in act (508). Otherwise the DIAC continues to wait for a user

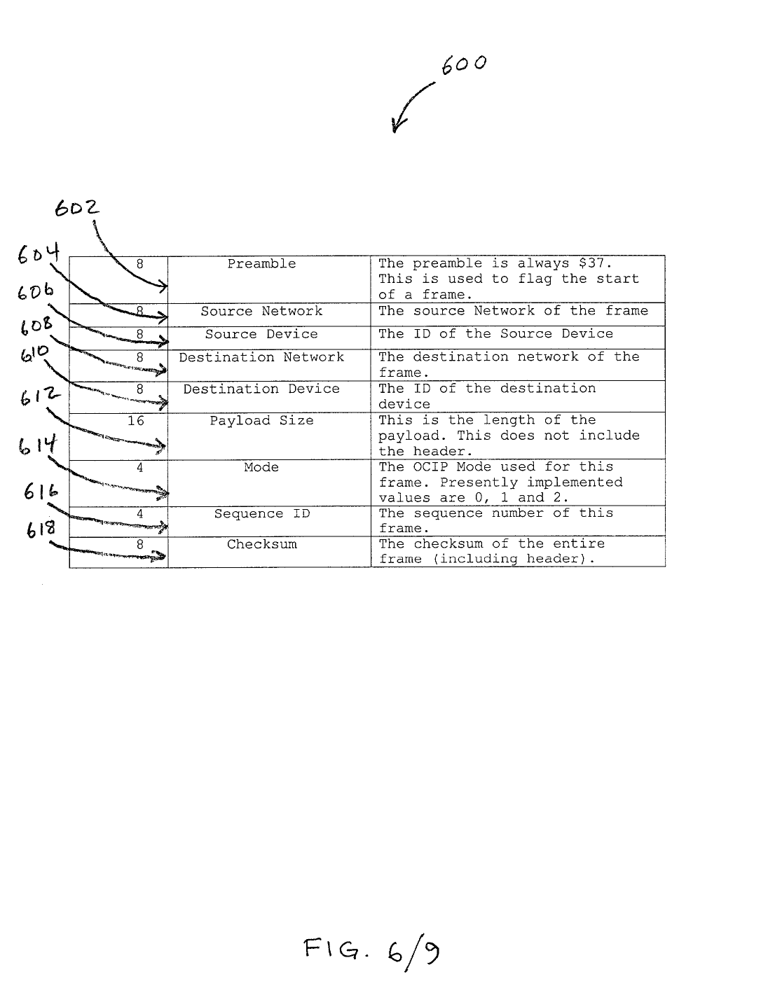

FIG. 6 illustrates one embodiment of an OCIP header format (600) in the embodiment shown, an 8 bit preamble (602) is provided. The preamble (602) is given in this embodiment by the character $37, which is used to flag the start of an OCIP frame. A source network (604) is also 8 bits long, and denotes the source network of the OCIP frame. The source device field (606) is an 8-bit ID of the source device. The destination network (608) is 8-bits long, and indicates the destination network of the OCIP frame. The destination device (610) is 8-bits long and provides the ID of the destination device. The payload size (612) is a 16-bit field containing the length of the OCIP frame payload. This length does not include the header. The mode (614) is 4-bits, and provides the OCIP mode used for this frame. For example, the mode (614) may be zero or one or two. The sequence ID (616) is 4-bits long. The sequence ID (616) provides information about the sequence number of an OCIP frame. Finally, the checksum (618) is an 8-bit entry, denoting the checksum of the entire frame (including header).

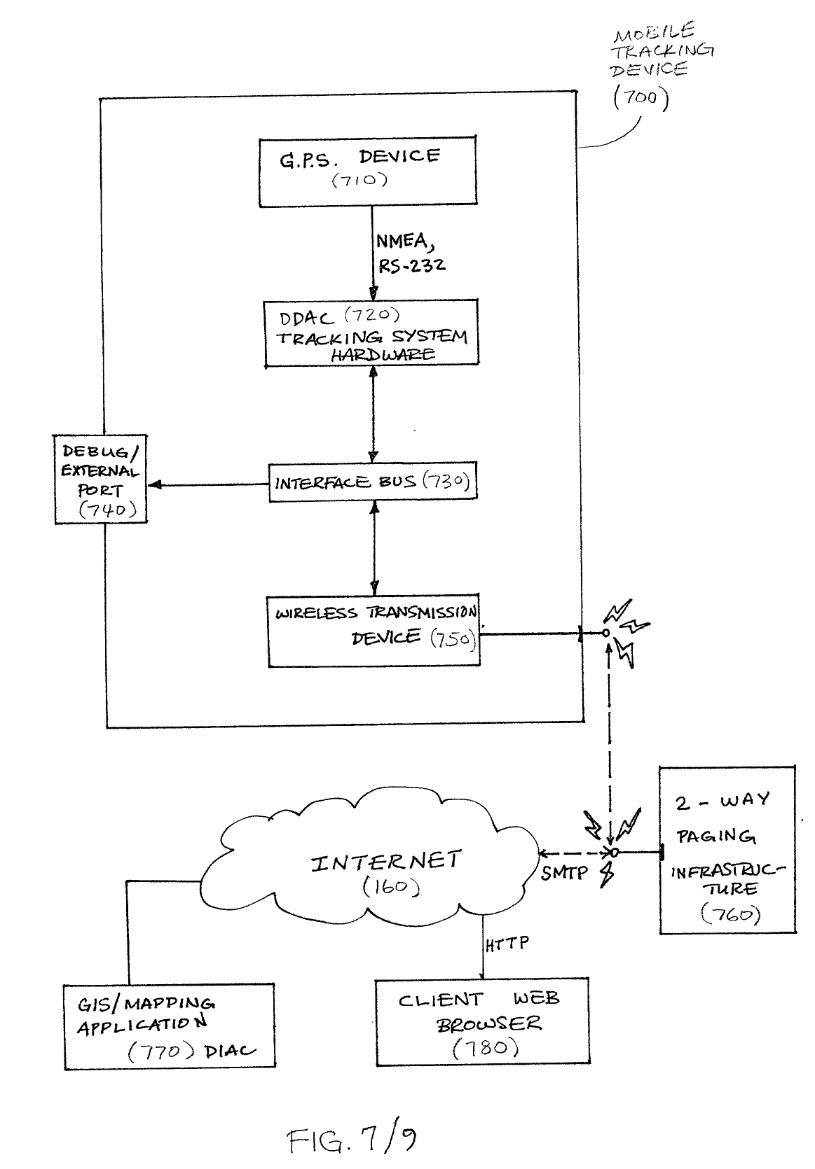

An embodiment of a telemetry application using GPS and a 2-way paging network is shown in FIG. 7. A mobile tracking device (700), consisting of a GPS device (710), communicating with the tracking system hardware (720) using a protocol such as NMEA or RS-232, an interface bus (730) coupled to the tracking system hardware (720) and a debugging or external port (740) as well as a wireless transmission device (750). The wireless transmission device (750) has a means for wireless communication with a 2-way written paging infrastructure (760).

The 2-way paging infrastructure (760) uses a protocol such as SMTP to communicate via the Internet (160). A GIS/mapping application (770) is also connected to the Internet and is adapted to provide a client web browser (780) with position and map information over the worldwide web or http connection. The 2-way paging infrastructure (760) may achieve wireless communication with the mobile tracking device (700) and an external network such as the internet (160) using any of the communication protocols described previously.

A client or a user, human or computer or device (170) can access the mapping and position information provided by the mapping application (770) using any console (180) as described previously. Other devices may be coupled to the system. For example, the external port (740) or an equivalent connection point may be used to couple the mobile tracking device (700) to other devices such as address books, personal digital assistance (PDA), personal computers, network enabled cellular telephones, etc. By so coupling the mobile tracking device (700) to external devices or data bases, the telemetry system may be personalized or made to take advantage of information in databases such as address books, appointment schedules, etc.

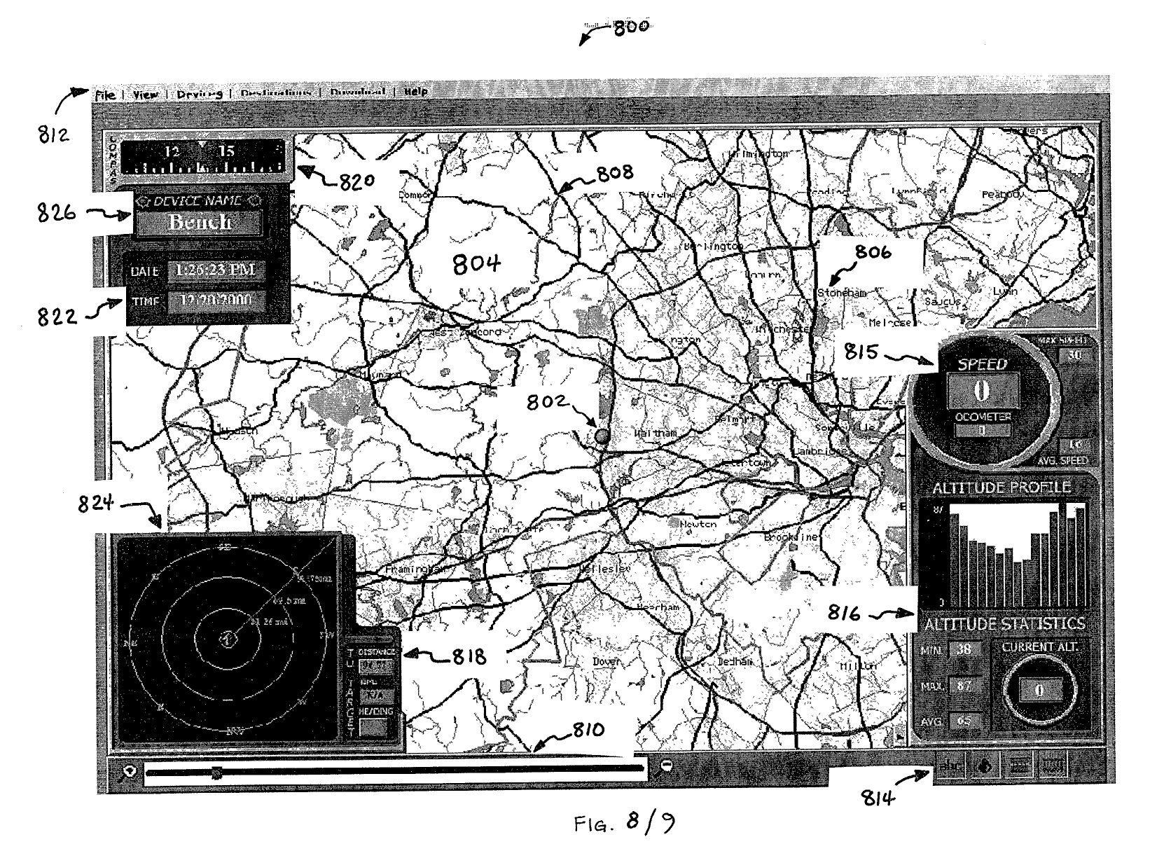

FIG. 8 illustrates the method for tracking mobile assets, and an embodiment of a user interface for such an application (800). The position (802) of an asset is shown relative to a map (804) may display features such as cities (806), roads (808), and other geographic features. The asset tracking application user interface may also have capabilities such as a zoom bar (810), a menu bar (812), and other indicative and optional features (814).

The tracking application interface may display various data regarding the asset being tracked visually on a graphical user interface, as an example. Such data may include the position (802), speed (815), maximum and average speed, altitude information (816), compass heading (820), date and time information (822), and other information (824) relevant to the position and tracking of the asset. A device name may be specified (826), or an IP address, or other identifying information may be shown in the graphical user interface to identify the asset. This may be helpful if a user (170) is tracking more than one asset position (802) using the same console (180). It should be understood that numerous other variations of such tracking applications (800) are possible, including those for tracking multiple assets simultaneously. In this case, the position indication (802) of an asset may be one of a plurality of such position indications (802), which could be designated graphically by using different colors, shapes, or characters to identify each asset individually. The user (170) may in some embodiments use a screen pointer (260) to move the pointer or click a button on an input device (250), for example, to bring up data on the screen relevant to that particular asset. Furthermore, it should be understood that other combinations or instances of information pertaining to an asset being tracked could also be displayed on the user interface of the console (180), or could be sent to a local or remote processing device for storage or communication therewith.

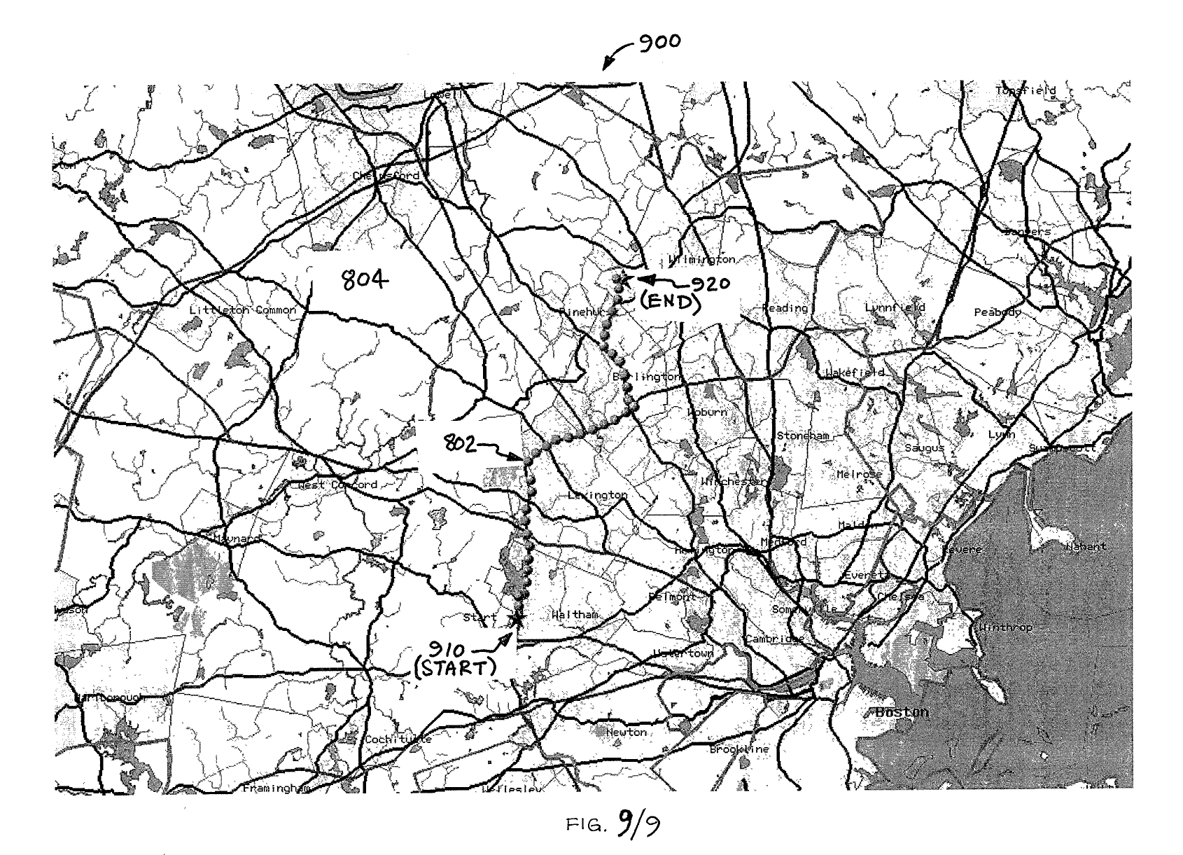

FIG. 9 shows an example of tracking a trip or an asset in motion, using multiple instances of an asset location representation (802). The figure shows a map (804) of a geographic region within which the asset is moving. At regular intervals, the asset position representation (802) is plotted on the map (804). This allows a graphical representation of the path taken by the asset starting at a start point (910), and ending at an end point (920). It should be clear that more than one asset may be so tracked simultaneously. The paths taken by the plurality of tracked assets in that case could be indicated by different color lines, or different characters or symbols used for each path. Those skilled in the art would recognize the utility of such graphical logging of asset position (802) for purposes of extracting historical data regarding the position of the assets. Such data indicated by the position and relative separation of successive asset position representations (802) can be used to extract speed, position, and other information as a function of time and space. From this information such as traffic flow and driver behavior may be obtained, for example, if one were tracking vehicles driven along the roadways (808).

While this invention has been illustrated with reference to preferred embodiments thereof, it will be understood by those skilled in the art that various changes in form and detail may be made thereon without departing from the scope of the invention as encompassed by the appended claims.

OCIP host communications between a host and a plurality of devices. OCIP support 255 devices per host and 255 hosts on a single physical network. Meaning up to 65025 devices can share a single physical network. Of course other embodiments can differ, as the DINA architecture is scalable.

OCIP Header

Each OCIP frame defining the properties of the OCIP frame. This header defines a preamble, the payload size, phase identifier, unique sequence ID, and a checksum (Table A.1).

TABLE A.1

| | | |
|---|---|---|
| 8 | Preamble | The preamble is always |
| | | $37. This is used to flag the |
| | | start of a frame. |
| 8 | Source Network | The source Network of the |
| | | frame |
| 8 | Source Device | The ID of the Source |
| | | Device |
| 8 | Destination | The destination network |
| | Network | of the frame. |
| 8 | Destination | The ID of the destination |
| | Device | device |
| 16 | Payload Size | This is the length of the |
| | | payload. This does not include |
| | | the header. |
| 4 | Mode | The OCIP Mode used for |
| | | this frame. Presently |
| | | implemented values are 0, 1 and |
| | | 2. |
| 4 | Sequence ID | The sequence number of |
| | | this frame. |
| 8 | Checksum | The checksum of the |
| | | entire frame (including |
| | | header). |

The first byte of the frame is the preamble. This byte is always hexadecimal 37 (decimal 55). This value is used to flag the start of an OCIP frame.

After the preamble the addressing information is sent. Each address is broken down into a Network and Device number. The Network ID indicates which logical device network the packet is destined for. The Source Device is the ID of the device that transmitted the frame. The Destination Device is the Device ID that the frame is destined for.

The next value is a 16-bit word. This value depicts the size of the payload. (The data following the header) The value is represented in high byte, low byte order. This length does not include the 5-byte header. The maximum payload size of an OCIP frame is 65535 bytes.

The 4-bit Mode identifier specifies which OCIP Mode is required to decode the payload. Devices can use this to easily ascertain what level of processing is required to interpret the frame or reject the frame if the specified Mode is not supported.

The 4-bit Sequence ID is used to match responses to their original request. This is part of the 2-way handshake as described below. The Sequence ID is an arbitrary value and is usually generated using pseudo-random technique that prevents repetitive values. A sequential value can also be used for ease.

The last 8 bits of the header specify the checksum. The checksum is used to help ensure data reliability. The checksum is computed by adding all bytes in the frame together with the checksum set to 0.

OCIP Phases

The payload of the OCIP frame is broken down into groups or Phases. The frame header Phase parameter defines which phase the frame uses.

Phase 0: RDM

Phase 1: CDM Phase 1

Phase 2: CDM Phase 2

RDM—Raw Data Mode

RDCM is used as a binary transport by OCIP. CDCM requires all data to be in clear text or BASE64 encoded, (resulting in a 33% size increase). For this reason RDCM is used to transport arbitrary binary data between devices. An RDCM frame is constructed by setting the “Phase” identifier in the OCIP header to 0. The payload of the frame can contain any arbitrary number of binary digits. RDCM can also be used as a control protocol, however no standard has been defined for RDCM based controls.

CDM—Contextual Data Mode

CDM is a contextual form of OCIP that allows for simple and complex controls to be sent within a single syntax. Unlike RDM which has no limitation to the characters used for data CDM has a limited number of characters that can be used. Also unlike RDM that provides no form of reliability control other than checksums, CDM utilizes a 2-way handshaking technique that aids in the reliable delivery of data.

CDM Handshaking

CDM utilizes a 2-way handshaking technique to ensure reliable delivery of frames. Each device has a sliding window that is used for data validation. When data is to be sent it is formatted into a valid frame with a unique Sequence ID and placed in the Transmit window. The frame is then transmitted to the remote device.

When the remote device receives the frame, it is decoded and acted upon. If the command is completed successfully an Acknowledgment frame is formatted with the same Sequence ID as the original frame and transmitted to the host.

When the host receives the acknowledgement frame it is placed in its receive window and matched to the original frame that was transmitted using the Sequence ID. Since there were no problems with the frame the window slides right to the next frame and the process is repeated.

If the remote device was unable to process the request due to an error, a Negative-Acknowledgement or NAK is returned to the lost. When the host receives the frame it is matched to the original frame using the Sequence ID. If the NAK was due to a communications failure (checksum, tt1, etc), the frame can be retransmitted to the device. If the NAK was due to a non-communications related error the frame is flagged with an error, dropped, and the Transmission window slides to the right and the process is repeated.

If no response is received from the remote device within a timeout period the frame is resent and the timeout is set with twice its original value. If still no response has been received after the second timeout the frame is dropped and an error status is returned.

Valid Characters

The CDM payload contains commands, and formatting data and information that is sent in clear text. A 96 character subset of US-ASCII is used to represent this data. For portability sake no other characters are allowed inside an OCIP payload. If binary data must be sent it should be sent using a RDM frame or encoded using BASE64 encoding. RDM should be used wherever possible since BASE64 encoding increases the data size by 33%.

CDM Phase I

The OCIP protocol has several forms known as Phases. The first form of contextual mode is Phase I. Phase I defines the most simplistic form of contextual device intercommunication. Under Phase I commands, known as Operations or op-codes, are sent followed by a semi-colon. ‘;’ All Operations are case sensitive. “Noop;” and “noop;” are considered different op-codes.

Format:

Operation;

Example:

noop;

Acknowledgements

Once the device has received the frame it should reply with an Acknowledgment (ack) that the frame was understood or a nak reply indicating that there was an error.

Acknowledgment

ack;

Negative Acknowledgment

nak;

An ACK could be sent after the requested operation has completed. If the host does not receive either an ACK or a NAK from the device it should assume that there are communication problems and attempt protocol synchronization.

CDM Phase II

OCIP Phase II builds on Phase I and outlines methods for passing extended parameters as part of an operation. The basic operation structure is the same as Phase I however additional parameters are passed in datasets. Each dataset has a parameter, value and an optional modifier. The modifier changes how the dataset is handled. A Phase II op-code can contain an unlimited number of datasets. Each group of datasets is surrounded by a set of brackets “{ }”.

Format:

OperationCode{

[modifier] Parameter: value;

}

Example:

readtemp{

format: celsius;
method: “Weighted Average”;

}

If the device receives a frame that contains extended datasets it can ignore them if they are not understood. If the dataset is required to be understood by the underlining device the keyword “required” should be used in conjunction with the dataset. For example:

In the above example the host requests the temperature with the “readtemp” op-code. It then uses a set of datasets to request the temperature in Celsius and as a weighted average. If the device receives this op-code but does not understand the requested methods it simply replies with a format and method that it does understand. If the host does not require the format to be Celsius but does require the device to return a weighted average. The following frame would be used.

readtemp{

format: celsius;
required method: “Weighted Average”;

}

If the remote host does not understand the parameter that is specified as ‘required’ it must return a NAK to the host indicating that the required method is not understood.

Modifiers Defined in CDM Phase II

| | |
|---|---|
| persistent | The parameter remains constant until the |
| | device is reset. |
| required | The device MUST understand the |
| | parameter. If it is not understood it |
| | should return a NAK. |
| lazy | Assumed. The parameter does not have to |
| | be understood. |

Parameters Defined in CDM Phase II

| | |
|---|---|
| format | Format of the reading, or response. |
| | (Celcius, inches, bytes, date, etc.) |
| method | Method that should be used to acquire the |
| | information. (Average, Direct) |
| priority | The operations priority. This is only |
| | pertinent in a device that is non-blocking. |
| | A priority of 0 is highest, 255 is the |
| | lowest. |

Acknowledgements

Phase II extends the acknowledgment structure to provide more information to the host device. Since there are many conditions that could cause a NAK to be sent having additional information indicating the cause of the problem helps the host determine what the best recovery method is. NAK types are reported as a textual response.

NAK{type:<nak type;>}

Example:

NAK{type: crc;}

Defined NAK types are:

| | |
|---|---|
| checksum | The frames checksum and the checksum computed |
| | on the payload do not match. Payload is corrupted. |
| framing | The first byte of the frame was not a valid preamble |
| | or the payload started early or late. |
| framelength | The frame is larger than the devices specified MTU. |
| nopayload | A frame was received with a payload length of 0. |
| notsupported | The specified Op-Code, parameter, or modifier is |
| | not understood or supported. |
| wouldblock | This operation would cause the device to block. |
| | (Only used in a non-blocking environment) |
| general | A general error has occurred. |
| busy | The device is currently busy handling another |
| | operation. (Only used in a non-blocking |
| | environment) |
| phase | The device does not support the OCIP phase |
| | defined. |
| incomplete | The payload was not found. |
| encoding | There was an error encoding or decoding the OCIP |
| | frame. Only occurs during BASE64 or Arithmetic |
| | coding.) |
| syntax | The syntax of the CDM content was invalid or not |
| | understood. |

CDM Parsing

White space should be ignored in the parsing of an CDM context. For example the following CDM commands have the same meaning:

readtemp {

format: celsius;
mode: “Weighted Average”;
}

readtemp {

format:

celsius;

mode:

“Weighted Average”;

}

readtemp{format:celsius;mode:”Weighted Average”;}

Since OCIP is intended to be a lightweight protocol it is recommended that the use of white spaces be avoided. This can greatly reduce not only the transmission overhead but also the processing requirements to parse the frame.

OCIP Addressing Schema

OCIP uses an addressing schema that is broken down into networks and devices. Each host device usually hosts its own logical network of devices. Each host is responsible for address allocation on its specific logical network. When a device is powered on and joins the network it uses a network ID of 0 and a device if of 0 until it has been able to acquire an address.

Addressing convention is written as a two octets separated by a period ‘.’. The first octet is the network number the second is the device ID. For example 09.01 indicates device 01 on network 09.

Broadcasts

Using hex FF as an address indicates a broadcast. Every host and device on the logical network should process a frame if it is a broadcast. Examples are of valid broadcasts are below.

$09.$FF: A broadcast to every device on the 09 network.

$FF.$FF: A broadcast to every network and every device.

Address Allocation

A device cannot communicate on the network until it has been assigned an address. When a device is first powered on it should broadcast an address request frame. Any hosts that are available should respond with offerings for addresses. The device then picks an address that is will use and returns an acknowledgement using that address. The host uses this ACK to complete its registration process. After the address allocation process has completed the host device should send a NOOP to verify that the device is able to communicate on its new address.

Registered Commands

ident*

The ident command requests the devices identification information. See below for more information on the ident response.

noop*

Noop is short for No Operation. When a device receives a NOOP it should return an ACK frame. The network and devices should use Noop as a ping to determine if a device is on or active. It can also be used to determine latency on the network.

reset*

Reset tells the device to reset to its power on defaults. This should include resetting the device to loose its assigned network and address parameters. This is usually used when a host powers on to reset any devices before reassigning addresses.

* Indicates commands to be supported for full OCIP compliance.

Identification Process

Each host needs to be able to identify a device. The frame that is returned from the device consists of several groups of information. Below is an example of an identification frame.

module{“

Appliance: VCR;
Manufacturer: Sharp;
Model: VC-A410;
Version: 0.0;
SerialNumber: 00000000;

}
capabilities{

CPU: PIC16C57;
Ram: 32;
EEProm: 2048;

}
io{

Mode: OCIP Phase III;
MTU: 16;

}
cmds {

ident;
noop;
reset;

}
microcode{

date: 6-28-2000 13:18;
compiled by: Operator X;
entity: Xypnos Technologies;
revision: 0.0;

}
}

Each group of information defines particular attributes about the device or how it functions.

Arithmetic Coding

Although the Huffman coding is optimal if each character must be encoded into a fixed (integer) number of bits, arithmetic coding wins if no such restriction is made.

As an example we shall encode “AABA” using arithmetic coding. For simplicity suppose we know beforehand that the probabilities for “A” and B” to appear in the text are ¾ and ¼, respectively.

Initially, consider an interval:

0<=x<1.

Since the first character is “A” whose probability is ¾, we shrink the interval to the lower ¾:

0<=x<¾.

The next character is “A” again, so we take the lower ¾:

0<=x<9/16.

Next comes “B” whose probability is ¼, so we take the upper ¼:

27/64<=x<9/16,

Because “B” is the second element in our alphabet, {A,B}, the last character is “A” and the interval is

27/64<=x<135/256,

Which can be written in binary notation

0.011011<=x<0.10000111.

Choose from this interval any number that can be represented in fewest bits, say 0.1, and send the bits to the right of “0.”; in this case we send only one bit, “1”. Thus we have encoded four letters into one bit. With Huffman coding, four letters could not be encoded into less than four bits.

To decode the code “1”, we just reverse the process: First, we supply the “0.” to the right of the received code “1”, resulting in “0.1” in binary notation, or ½. Since this number is in the first ¾ of the initial interval 0<=x<1, the first character must be “A”. Shrink the interval into the lower ¾. In this new interval, the number ½ lies in the lower ¾ part, so the second character is again “A”, and so on. The number of letters in the original file must be sent separately (or a special ‘EOF’ character must be appended at the end of the file).

The algorithm described above requires that both the sender and receiver know the probability distribution for the characters. The adaptive version of the algorithm removes this restriction by first supposing uniform or any agreed-upon distribution of characters that approximates the true distribution, and then updating the distribution after each character is sent and received.

Base64 Content-Transfer-Encoding

The Base64 encoding is designed to represent arbitrary sequences of binary octets in a form that is transmittable over under clear text restrictions. The encoding and decoding algorithms are simple, but the encoded data are consistently 33 percent larger than the original data. This encoding is based on the one used in Privacy Enhanced Mail applications, as defined in RFC 1113. The base64 encoding is adapted from RFC 1113, with two minor changes: base64 eliminates the “*” mechanism for embedded clear text and treats decoding anomalies differently.

A 65-character subset of US-ASCII is used, enabling 6 bits to be represented per printable character. (The extra 65th character, “=”, is used to signify a special processing function.) NOTE: This subset has the important property that it is represented identically in all versions of ISO 646, including US ASCII, and all characters in the subset are also represented identically in all versions of EBCDIC.

Other popular encoding methods, such as the encoding used by the UUENCODE utility and the BASE85 encoding specified as part of Level 2 PostScript, do not share these properties, and thus do not fulfill the portability requirements a binary transport encoding for mail must meet.

For further information please refer to the information on BASE64 encoding under RFC 1113.

### APPENDIX A

Preferred Embodiment of the Object Control and Information Protocol (OCIP)

When defining a protocol that is to be used for device independent imbedded control applications the most important aspect was the protocols ability to be applied to any environment. The protocol that would be used to control a household appliance such as a toaster would also need to be able to control industrial and even military applications. The protocol would also need to be able to be interpreted by processors with an extremely low memory footprint. And last but not least it must also be able to adapt with time to fit ever more complex systems that are being created. The Object Control and Information Protocol (OCIP) has been designed to address these requirements.

OCIP has been created by Xypnos Technologies, Inc. to provide a lightweight, device-independent form of control and information exchange. The OCIP protocol is a frame-based protocol. A header that defines a set of parameters precedes each command or dataset. This header is used for synchronization, routing, error control, and data validation. Immediately following the header is the actual OCIP data.

When a frame has been received it is validated. A checksum is computed on the data then matched to the checksum contained in the header. If the checksums match the frame is deemed valid then processed. If the checksums do not match the frame is rejected and an error code is returned to the originator of the frame.

Due to the device independent nature of OCIP it has been designed to be able to be transmitted over any medium. It can seamlessly be used over RS232, X10, Ethernet, TCP/IP, RF Transmission, WAP, and even through e-mail. This lends to its ability to be used in any environment.

OCIP relies on two sub methods for data transfer, which will be discussed in more detail later. The first is RDM and provides a non-reliable binary mode of communication. RDM is usually only used as to transmit binary data when necessary.

The second is CDM. Contextual Data Mode provides an architecture for simple or complex independent controls. CDM also supports compression and data encryption.

1. A system, comprising:
a device-independent access controller (DIAC), having a DIAC network address, adapted for coupling to a network;
a device-dependent access controller (DDAC), having a DDAC network address, adapted for coupling to the network, and adapted for coupling to a device, said device having a corresponding device functionality set;
wherein the DIAC and the DDAC can communicate over the network using a communication protocol; and
wherein the communication protocol supports a set of device-dependent commands, carried onboard the DDAC, said set of device-dependent commands allowing the DIAC access to the device functionality set.

2. The system claimed in claim 1, further comprising a user, wherein said user can be any of a human, a computer, and a device comprising at least a data processor.

3. The system claimed in claim 1, wherein the DIAC is adapted for coupling to an external network.

4. The system claimed in claim 3, wherein the external network is the Internet.

5. The system claimed in claim 1, wherein the DIAC is adapted for coupling to a second device.

6. The system claimed in claim 5, wherein the second device has a second device functionality set.

7. The system claimed in claim 1, wherein the DIAC is adapted for hosting a user interface software client.

8. The system claimed in claim 7, wherein the user interface allows the user to access the device functionality set of at least one device coupled to the network.

9. The system claimed in claim 7, wherein the user interface is a graphical user interface.

10. The system claimed in claim 1, wherein the access to the device functionality set is accomplished using an intermediary device access controller coupled to the device via the network.

11. The system claimed in claim 1, wherein the DIAC and the DDAC are coupled to the same device.

12. The system claimed in claim 1, further comprising a console adapted for coupling to the network.

13. The system claimed in claim 12, wherein the console is any of: a computer running an application program, a computer running a World Wide Web browser, a Wireless Access Protocol (WAP) appliance, a telephone, a personal digital assistant (PDA), or a custom console for accessing the network.

14. The system claimed in claim 1, wherein the DIAC and DDAC communicate using any of: the Internet, an Ethernet connection, a wireless radio frequency (RF) channel, a telephone line, a fiberoptic data line, a cable television line, a modem connection, a wireless pager/packet network, a Bluetooth network, a Local Area Network (LAN), or a Wide Area Network (WAN); X-10 electric power line.

15. The system claimed in claim 1, wherein the device functionality includes data acquisition.

16. The system claimed in claim 15, wherein the data includes the device position.

17. The system claimed in claim 15, wherein the data is stored onboard the DDAC.

18. The system claimed in claim 15, wherein the data is stored onboard the device.

19. The system claimed in claim 15, wherein the data is delivered to another device coupled to the network.

20. The network claimed in claim 1, further comprising a plurality of DDACs, each DDAC having a corresponding DDAC network address and being coupled to the network.

21. The network claimed in claim 1, wherein the DDAC network address is assigned by the DIAC.

22. The network claimed in claim 1, wherein the DIAC acts as a master controller.

23. The network claimed in claim 1, wherein the device is a component within a multi-component device.

24. The network claimed in claim 1, wherein the device is one of an ensemble of home appliances coupled to the network.

25. A system, comprising:
a DIAC having a DIAC network address, adapted for coupling to a network;
a DDAC, having a DDAC network address, adapted for coupling to the network, and adapted for coupling to a device, said device having a corresponding device functionality set;
wherein the DIAC and the DDAC can communicate over the network using a communication protocol; and
wherein the communication protocol supports a set of device-dependent commands, obtained from information content found on an external network, said set of device-dependent commands allowing the DIAC access to the device functionality set.

26. A device-independent access controller (DIAC) adapted for coupling to a network operatively capable of using a communication protocol for communicating with a device-dependent access controller (DDAC) coupled to the network, wherein the DIAC uses a list of device-dependent operations, obtained from a source other than onboard said DIAC to exchange data with the DDAC.

27. The DIAC claimed in claim 26, wherein the DIAC is implemented as custom hardware in the form of an application-specific integrated circuit (ASIC).

28. The DIAC claimed in claim 26, wherein the DIAC is implemented in hardware suitable for use in applications other than a DIAC, by execution of software commands on said hardware to achieve equivalent DIAC operations in the hardware.

29. The DIAC claimed in claim 26, wherein the DIAC is implemented in software, used in conjunction with an operating system and corresponding hardware.

30. A device-dependent access controller (DDAC) adapted for coupling to a network, and adapted for coupling to a first device, said first device having a first device functionality set which is accessible to a second device coupled to the network, wherein the second device communicates with the DDAC using the network and using a communication protocol which includes a data representation corresponding to a first device functionality set, said data representation not being stored onboard the second device or onboard an embedded feature therein.

31. The DDAC claimed in claim 30, wherein the DDAC is implemented as custom hardware in the form of an application-specific integrated circuit (ASIC).

32. The DDAC claimed in claim 30, wherein the DDAC is implemented in a circuit provided by the first device manufacturer at the time of production of the first device.

33. The DDAC claimed in claim 30, wherein the DDAC is a stand-alone circuit not embedded in the first device, having connections to the first device circuitry to allow it access to a first device functionality set.

34. A method for network-enabling devices, comprising:
connecting at least one DIAC to at least one device containing a DDAC;
operatively using a communication protocol for passing a DIAC signal from the DIAC to the DDAC; and
returning a DDAC signal from the DDAC to the DIAC in response to the DIAC signal.

35. The method claimed in claim 34, further comprising executing a function on a device, said function corresponding to a command signal sent by the DIAC.

36. The method claimed in claim 34, wherein the act of returning a DDAC signal includes returning an acknowledgement signal.

37. A method for tracking a mobile asset comprising:
obtaining position data for a position of the mobile asset using a network-enabled positioning device coupled to a first device controller;
transmitting the position data over a wireless communication network using a first communication device coupled to the first device controller;
receiving the position data over the wireless communication network using a second communication device coupled to a data communication network; and
delivering the position data, once received by the second communication device, to a second device controller coupled to the data communication network.

38. The method of claim 37, further comprising presenting the position data to a user in a graphical form.

39. The method of claim 38, wherein the act of presenting the position data to a user in graphical form includes presenting position data samples represented graphically on a map of a geographic region, showing the position of the mobile asset at discrete sampling times.

40. The method of claim 37, wherein the mobile asset is any of a motor vehicle; a marine vessel; a package; a shipping container; an aircraft; and a human being.

41. The method of claim 37, wherein the position data is a set of geographic coordinates including any of: latitude; longitude; and altitude.

42. The method of claim 41, further comprising recording the position data onto a networked storage device.

43. The method of claim 42, wherein the act of recording the position data onto a networked storage device includes recording the position data onto any one of: a computer memory; a magnetic storage medium; an optical storage medium; and a printing apparatus.

44. The method of claim 37, further comprising buffering at least one position data sample in a storage buffer collocated with the asset.

45. The method of claim 44, wherein the storage buffer is integrated into the mobile asset.

46. A system for tracking a mobile asset, comprising:
a first device controller, coupled to a positioning device, said positioning device adapted for obtaining a position of the mobile asset;
a first communication device, coupled to the first device controller, adapted for transmitting position data over a wireless communication network;
a second communication device, adapted for receiving position data over the wireless communication network;
a data communication network; and
a data processing device, coupled to the data communication network and to a second device controller, adapted for processing the position data received by the second communication device.

47. The system of claim 46, wherein the first network-enabled communication device is a paging device.

48. The system of claim 46, wherein the second network-enabled communication device is a paging base station.

49. The system of claim 46, wherein the wireless network is a two-way paging network.

50. The system of claim 46, wherein both the positioning device and the first communication device are collocated within an integrated wireless positioning apparatus.

51. The system of claim 46, wherein a plurality of first device controllers are coupled to a plurality of positioning devices, said plurality of positioning devices adapted for obtaining a plurality of positions corresponding to a plurality of mobile assets.
